(19) United States
(12) Patent Application Publication
(10) Pub. No.: US 2008/0099694 A1
(43) Pub. Date: May 1, 2008

(54) SCINTILLATOR PANEL

(76) Inventors: Takehiko SHOJI, Tokyo (JP); Yasushi Nagata, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/877,245

(22) Filed: Oct. 23, 2007

(30) Foreign Application Priority Data
Oct. 26, 2006 (JP) JP2006-290875

(51) Int. Cl. G01T 1/20

(52) U.S. Cl. 250/483.1

(57) ABSTRACT

A scintillator panel comprising a substrate having thereon a reflective layer and a scintillator layer, wherein a light absorbing layer having a maximum absorption wavelength of 560 to 650 nm is provided between the reflective layer and the scintillator layer.

This application is based on Japanese Patent Application No. 2006-290875 filed on Oct. 26, 2006 in Japanese Patent Office, the entire content of which is hereby incorporated by reference.

### FIELD OF THE INVENTION

The present invention relates to a scintillator panel used to form the radiation image of a subject.

### BACKGROUND OF THE INVENTION

The radiation image represented by a radioscopic image has been widely used to diagnose the state of disease in the medical field. As a result of efforts made for higher sensitivity and higher image quality in its long history, the radiation image based on the sensitized paper-film system in particular is still used in the medical field all over the world, as an imaging system characterized by a combination of a high degree of reliability and excellent cost performances. However, such image information is so-called analog information, and is not built for free image processing or instantaneous transmission of information as in the digital image information which is making a remarkable progress in recent years.

In recent years, a digital radiation image detecting apparatus as represented by the Computed Radiograph (CR) and flat panel detector (FPD) has come on the market. This apparatus permits direct capturing of a digital radiation image and direct display of an image on an image display apparatus such as a cathode tube and liquid crystal panel. It does not necessarily require formation of an image on the photographic film. As a result, such a digital radioscopic image detecting apparatus has reduced the need of forming an image by silver halide photographic method, and has greatly contributed to the enhancement of convenience in diagnosis at a hospital and clinic.

The Computed Radiograph (CR) as one of the digital technology for radioscopic image is accepted in the field of medical treatment. However, the level of sharpness and spatial resolution are not still fully sufficient. This technology has not yet reached the level of quality required in the screen/film system. Further, a still new digital radioscopic image technology has been introduced, for example, as a flat panel X-ray detector (FPD) using a thin film transistor (TFT) which is disclosed by John Rowland, “Amorphous Semiconductor Usher in Digital X-ray Imaging” in a journal Physics Today, November 1997, P. 24, and L. E. Antonuque, “Development of a High Resolution, Active Matrix, Flat-Panel Imager with Enhanced Fill Factor” in a journal SPIE, 1997, Vol. 32, P. 2.

A scintillator panel formed of an X-ray phosphor capable of emitting light by radiation is used to convert radiation into visible light. To improve the SN ratio in a low-dose imaging operation, it is necessary to use a scintillator panel of high light emitting efficiency. Generally, the light emitting efficiency of a scintillator panel is determined by the thickness of the scintillator layer (phosphor layer) and X-ray absorption index of the phosphor. As the phosphor layer is made thicker, the light emitted inside the phosphor layer is scattered and the image sharpness is reduced. Thus, the film thickness is determined by the image sharpness required for the image quality.

Cesium iodide (CSI) exhibits a higher rate of conversion from X-ray to visible light, and the phosphor can be easily formed into a columnar crystal structure by vacuum evaporation. Accordingly, scattering of the light emitted inside the crystal can be reduced by the light guiding effect. This has made it possible to increase the thickness of the phosphor layer.

However, light emitting efficiency is too low if the CSI alone is used. Accordingly, as described in the Examined Japanese Patent Publication No. 54-35060, the mixture of the CSI with sodium iodide (NaI) at a desired mole ratio is deposited on the substrate as a sodium-activated cesium iodide (CSI: Na) by vacuum evaporation. Alternatively, in recent years, the mixture of the CSI with thallium iodide (TiI) at a desired ratio is deposited on a substrate as a thallium activated cesium iodide (CSI: TI) by vacuum evaporation. The resulting product is provided with annealing in a later process, whereby the efficiency of conversion into visible light is enhanced. This product is used as an X-ray phosphor.

To increase light output, other approaches have been proposed, as exemplified by the method of making the substrate constituting the scintillator reflective (e.g., Patent Document 1), a method of providing a reflective layer on the substrate (e.g., Patent Document 2), and the method of forming a scintillator on the reflective metallic thin film arranged on the substrate and a transparent organic film covering the metallic thin film (e.g., Patent Document 3). However, although the amount of light can be increased by these methods, the image sharpness is considerably reduced.

In the case in which the scintillator panel is arranged on the flat light receiving element, it is possible to use the methods disclosed, for example, in the Japanese Patent Application Publication Open to Public Inspection (hereafter referred to as JP-A) Nos. 5-312961, and 6-331749. However, the resulting production efficiency is not fully high and the image sharpness on the scintillator panel is not fully maintained when the image is transferred to the flat light receiving element.

In the method of manufacturing a scintillator by vapor deposition method, it is a common practice to form a phosphor layer on a rigid substrate, for example, aluminum or amorphous carbon, and to cover it with a protective film over the entire surface of the scintillator (Patent Document 4). However, if a phosphor layer is formed on the substrate which cannot be bent freely, when the scintillator panel and flat light receiving element surface are bonded together, uniform image quality cannot be obtained inside the light receiving surface of the flat panel detector, due to, for example, deformation of the substrate and curling occurring the vapor deposition process. This problem is becoming more serious with the recent upsizing of a flat panel detector.

To avoid this problem, it is a common practice to form a scintillator directly on the imaging element by vacuum evaporation, or to use a flexible medical intensifying screen, although the sharpness is not high, as a substitute of the scintillator panel. Further, there is an example of using such as a flexible protective layer of polyparaxylylene (Patent Document 5). However, the aluminum and amorphous carbon used as a substrate are rigid, and a uniform contact of the scintillator panel surface and flat light receiving element surface cannot be achieved due to the roughness or curling of the substrate.

To meet the aforementioned situation, there has been a intense demand for development of a radiation flat panel detector that is characterized by the satisfactory amount of light and the image sharpness without deterioration in the image sharpness when an image is received by a flat light receiving element.

| | |
|---|---|
| Patent Document 1 | Examined Japanese Patent |
| | Publication No. 7-21560 |
| Patent Document 2 | Examined Japanese Patent |
| | Publication No. 1-240887 |
| Patent Document 3 | Japanese Patent Application |
| | Publication Open to Public Inspection |
| | (hereafter referred to as JP-A) |
| | No. 2000-356679 |
| Patent Document 4 | Japanese Patent No. 3566926 |
| Patent Document 5 | JP-A No. 2002-116258 |

### SUMMARY OF THE INVENTION

An object of the present invention is to provide a scintillator panel exhibiting excellent light extraction efficiency, high image sharpness and limited deterioration of the image sharpness when an image is received by a flat light receiving element.

One of the aspects to achieve the above object of the present invention is a scintillator panel comprising a substrate having thereon a reflective layer and a scintillator layer, wherein a light absorbing layer having a maximum absorption wavelength of 560 to 650 nm is provided between the reflective layer and the scintillator layer.

### BRIEF DESCRIPTION OF THE DRAWINGS

FIG. 1 is a cross sectional view showing the schematic structure of the scintillator panel 10 for radiation.

FIG. 2 is an enlarged cross sectional view of the radiation scintillator panel 10 for radiation.

FIG. 3 is a schematic cross sectional view showing the structure of the vacuum evaporation apparatus 61.

FIG. 4 is a schematic partial perspective view illustrating the structure of the radiation image detector 100.

FIG. 5 is an enlarged cross sectional view showing an imaging panel 51.

### DESCRIPTION OF THE PREFERRED EMBODIMENTS

The above object of the present invention can be achieved by the following structures:
(1) A scintillator panel comprising a substrate having thereon a reflective layer and a scintillator layer, wherein a light absorbing layer having a maximum absorption wavelength of 560 to 650 nm is provided between the reflective layer and the scintillator layer.
(2) The scintillator panel of Item (1), wherein the light absorbing layer comprises an organic colorant or an inorganic colorant.
(3) The scintillator panel of Item (1) or (2), wherein the scintillator layer is formed by a vapor deposition method using a raw material comprising cesium iodide and an additive comprising thallium.
(4) The scintillator panel of any one of Items (1) to (3), wherein a thickness of the light absorbing layer is 0.2 to 2.5 μm.
(5) The scintillator panel of any one of Items (1) to (4), wherein the reflective layer comprises an element selected from the group consisting of Al, Ag, Cr, Cu, Ni, Ti, Mg, Rh, Pt and Au.

According to the aforementioned structure of the present invention, a scintillator panel exhibiting excellent light extraction efficiency, high image sharpness and limited deterioration of the image sharpness when an image is received by a flat light receiving element is provided.

The scintillator panel of the present invention is a scintillator panel wherein a reflective layer and scintillator layer are provided on a substrate, and a light absorbing layer having a maximum absorption wavelength of 560 through 650 nm is arranged between the reflective layer and the scintillator layer. These characteristics are the technological features common to the inventions related to above Items 1 through 5.

A “scintillator” of the present invention refers to a phosphor which absorbs energy of a radiation, for example, X-ray to emit electromagnetic waves having wavelengths of 300 nm through 800 nm, namely, the electromagnetic waves (light) ranging from ultraviolet to infrared including visible light in the center.

It was found in the present invention it was found that the aforementioned characteristic technological structures makes it possible to drastically enhance the image sharpness without notable deterioration of light extraction efficiency by reducing the light component having longer wavelengths of 560 nm or more in the light reflected by the reflective layer.

The following describes the details of the present invention and its components thereof.

### (Construction of Scintillator Panel)

The scintillator panel of the present invention is a scintillator panel wherein a reflective layer and scintillator layer are provided on the substrate, and a light absorbing layer having a maximum absorption wavelength of 560 through 650 nm is arranged between the reflective layer and scintillator layer.

In the present invention, a protective layer to be described later is preferably provided in addition to the reflective layer, light absorbing layer and scintillator layer.

The following describes each component layer and component element.

### (Light Absorbing Layer)

The light absorbing layer of the present invention is provided between the reflective layer and scintillator layer, wherein the maximum absorption wavelength is in the range of 560 through 650 nm.

This light absorbing layer preferably contains a pigment or a dye to ensure that the maximum absorption wavelength is in the range of 560 through 650 nm.

Further, this light absorbing layer preferably contains a polymer binder and a dispersant.

The thickness of the light absorbing layer is preferably in the range of 0.2 through 2.5 μm from the viewpoint of obtaining high image sharpness and light extraction efficiency.

The following describes the component elements of the light absorbing layer:

### <Colorant>

In addition to the commercially available colorant, the conventionally known colorant described in various documents is preferably used as a colorant having a maximum absorption wavelength of 560 through 650 nm used in the present invention.

The colorant preferably absorbs in the wavelength range of 560 through 650 nm. The organic or inorganic colorant ranging from violet to blue is preferably utilized.

The organic of colorant ranging from violet to blue is exemplified by dioxazine for violet, and phthalocyanine blue and indanthrene for blue. The examples include Zabon First Blue 3G (by Hoechst), Estrol Brill Blue N-3RL (by Sumitomo Chemical Co., Ltd.), Sumi Acryl Blue F-GSL (by Sumitomo Chemical Co., Ltd.), D & C Blue No.1 (by National Aniline Co., Ltd.), Spirit Blue (by Hodogaya Chemical Co., Ltd.), Oil Blue No.603 (by Orient Co., Ltd.), Kiton Blue A (by Ciba Geigy Co., Ltd.), Aizen Catiron Blue GLH (by Hodogaya Chemical Co., Ltd.), Lake Blue A, F, H (by Kyowa Industries Co., Ltd.), Rodarin Blue 6GX (by Kyowa Industries Co., Ltd.), Primo Cyanine 6GX (by Inabata Industries Co., Ltd.), Brill Acid Green 6BH ((by Hodogaya Chemical Co., Ltd.), Cyanine Blue BNRS (by Toyo Ink Co., Ltd.), and Lionol Blue SL (by Toyo Ink Co., Ltd.).

The inorganic colorant in the range of violet-blue-blue-green is exemplified by ultramarine blue pigment, cobalt blue, cerulean blue, chromium oxide and TiO₂—ZnO—CoO—NiO pigment, however, the present invention is not limited thereto.

The most preferred pigment is a metal phthalocyanine pigment. The metal phthalocyanine pigment is exemplified by copper phthalocyanine. However, as long as the maximum absorption wavelength is in the range of 570 through 650 nm, other metal-containing phthalccyanine pigment, for example, pigment based on zinc, cobalt, ion, nickel and other such metals can also be used. The appropriate phthalocyanine pigment can be either unsubstituted or substituted (for example, by one or more of alkyl, alkoxy and halogen such as chlorine, or by a substituent typical to other phthalocyanine pigment). The crude phthalocyanine can be prepared technologically by any of the conventionally known methods. It is preferably prepared by reaction with metal doner or nitrogen doner, for example, anhydrous phthalic acid, phthalonitrile or its derivative (e.g. urea or phthalonitrile itself) preferably in the presence of an catalyst in the organic solvent. The following references can be cited, for example: W. Herbst and K. Hunger, “Industrial Organic Pigment”, “VCH Publisher, New York, 1993”, pp. 418-427; H. Zollinger, “Coolant Chemistry”, (VCH Publisher, New York, 1973), pp. 101-104; and “Chemistry of Synthetic Dye and Pigment” edited by N. M. Pigelow, M. A. Perkins, H. A. Lubs; “Robert E. Krieger published in 1955”, “Phthalocyanine pigment” in pp. 584-587”, U.S. Pat. Nos. 4,158,572, 4,257,951 and 5,175,282, and U.K. Patent First 1502884.

### <Polymer Binder>

In the present invention, the pigment is used in the form dispersed in a polymer binder. Various forms of dispersant can be used according to the binder and pigment to be used. The binder is preferably a polymer having a glass transition temperature (Tg) of 30 through 100° C. in point of adhesion with vapor deposition crystal and substrate. Especially a polyester resin is preferably used as the binder.

Examples of the dispersant include phthalic acid, stearic acid, caproic acid and lipophilic surface active agent.

The pigment is dispersed in the binder by the conventionally known technology used in ink production and toner production processes. The homogenizer is exemplified by a sand mill, attriter, pearl mill, super mill, ball mill, impeller, disperser, KD mill, colloid mill, dynamitron, three-roll mill and pressure kneader. Details are described in “State-of-the-art Pigment Application Technology” (CMC Publisher, 1986).

The light absorbing layer of the present invention is preferably manufactured by coating the resin dissolved in solvent, and drying the same. Examples of this resin include polyurethane, polyvinyl chloride copolymer, polyvinyl chloride-vinyl acetate copolymer, polyvinyl chloride-vinylidene chloride copolymer, polyvinyl chloride-acrylonitrile copolymer, butadiene-acrylonitrile copolymer, polyamide resin, polyvinyl butylal, polyester, cellulose derivative (nitrocellulose, etc.), styrene-butadiene copolymer, various forms of synthetic rubber resin, phenol resin, epoxy resin, urea resin, melamine resin, phenoxy resin, silicon resin, acryl based resin, and urea formaldehyde resin. Among others, polyurethane, polyester, polyvinyl chloride copolymer, polyvinyl butylal and nitrocellulose are preferably utilized. Especially, the resin having a glass transition temperature of 30 through 100° C. is preferably included. When a scintillator is formed by vapor deposition, it is a common practice to set the substrate temperature at 150° C. through 250° C. When a resin having a glass transition temperature of 30 through 100° C. is included in the underlying layer, the light absorbing layer effectively functions as an adhesive layer as well.

The solvent used to manufacture a light absorbing layer is exemplified by lower alcohol such as methanol, ethanol, n-propanol and n-butanol; a hydrocarbon containing chlorine atom such as methylene chloride and ethylene chloride; a ketone such as acetone, methyl ethyl ketone and methyl isobutyl ketone; an aromatic compound such as toluene, benzene, cyclohexane, cyclohexanone, and xylylene; ester between a lower fatty acid such as methyl acetate, ethyl acetate and butyl acetate and a lower alcohol; an ether such as dioxane, ethylene glycol monoethyl ester and ethylene glycol monomethyl ester; and a mixture of these substances.

The content of the colorant in the light absorbing layer is preferably 0.01-1.0% by mass based on the total mass of the light absorbing layer after it is applied and dried.

### (Scintillator Layer)

Various forms of conventionally known phosphor materials can be utilized as a material forming a scintillator layer (also referred to as “phosphor layer”). Cesium iodide (CSI) is preferably used, because the high ratio of change from the X-ray to the visible light is comparatively high, and phosphor can be easily formed into a columnar crystal structure by vapor deposition. This reduces scattering of the light emitted inside the crystal by the light guiding effect and increases the thickness of the scintillator layer (phosphor layer).

However, CSI alone is characterized by a low light emitting efficiency. To make up for this defect, various forms of activators are added. The example includes a mixture of the CSI and sodium iodide (Nal) at a desired mole ratio, as disclosed in the Unexamined Japanese Patent Application Publication No. S54-35060 (Tokkosho). Further, as disclosed in the Unexamined Japanese Patent Application Publication No. 2001-59899 (Tokkai), the CSI is processed by vapor deposition and is formed into the CSI containing such an activating material as Indium (In), thallium (TI), lithium (Li), potassium (K), rubidium (Rb) and sodium (Na).

In the present invention in particular, the additive including one or more thallium compounds, and cesium iodide are preferably used as raw materials. This is preferred because the thallium activating cesium iodide (CSI: TI) has a light emitting wavelength ranging from 400 nm to 750 nm.

Various forms of thallium compounds (compound having a oxidation number of +I and +III) can be used as the thallium compound of the additive including one or more thallium compounds of the present invention.

In the present invention, the preferable examples of the thallium compound include thallium bromide (TlBr), thallium chloride (TlCl) or thallium fluoride (TlF, TlF₃).

The melting point of the thallium compound in the present invention is preferably in the range of 400 through 700° C. If the temperature exceeds 700° C., the additive inside the columnar crystal is non-uniformly present, and light emitting efficiency is reduced. The melting point in the present invention refers to the melting point under the normal temperature and pressure.

The molecular weight of the thallium compound preferably lies in the range of 206 through 300.

In the scintillator layer of the present invention, the amount of the additive contained should be the optimum in conformity to the intended performances. It is preferably in the range of 0.001 mol % through 50 mol %, with respect to the amount of cesium iodide contained, more preferably in the range of 0.1 through 10.0 mol %.

If the amount of additive is less than 0.001 mol % with respect to that of cesium iodide, the luminance of the emitted light is almost the same as when cesium iodide alone is used. The intended luminance of the emitted light cannot be obtained. If the amount of additive is more than 50 mol %, the properties and functions of cesium iodide cannot be maintained.

### (Reflective Layer)

The reflective layer of the present invention is used to reflect the light emitted from the scintillator and to increase the light extraction efficiency. This reflective layer is preferably made up of a material including any element selected from the element group of Al, Ag, Cr. Cu, Ni, Ti, Mg, Rh, Pt and Au. Especially, a thin metallic film made up of the aforementioned element such as Ag film and Al film is preferably used. It is also possible to form two or more such thin metallic films.

The thickness of the reflective layer is preferably in the range of 0.01 through 0.3 μm for the purpose of enhancing the emitted light extraction efficiency.

### (Protective Layer)

The protective layer of the present invention is intended to protect the scintillator layer. To be more specific, cesium iodide (CsI) has a high hygroscopic property. If it is exposed to the outside, the cesium iodine will dissolve and become liquid by absorbing moisture from the air. This is prevented by the protective layer of the present invention.

This protective layer can be formed of various forms of materials. For example, a polyparaxylylene film can be formed by the CVD method. To be more specific, a polyparaxylylene film is formed over the entire surface of the scintillator and substrate and this can be used as a protective layer.

In another form of the protective layer, a polymer protective film can be formed on the scintillator layer.

The thickness of the aforementioned polymer protective film is preferably 12 μm to 60 μm, more preferably 20 μm to 40 μm when consideration is given to the formation of a void, protection of a scintillator (phosphor) layer, sharpness, moisture proofing and working efficiency. The haze ratio is preferably 3% to 40%, more preferably 3% to 10% when consideration is given to sharpness, irregularity on radiation image, manufacturing stability and working efficiency. The value measured by the NDH 5000W (by Nippon Denshoku Co., Ltd.) is given to show the haze ratio. The required haze ratio can be easily obtained by selection from commercially available polymer films.

With consideration given to photoelectric conversion efficiency, the wavelength of the light emitted from the scintillator and others, the light transmittance of the protective film is preferably 70% or more at 550 nm. The optically transparent film having a light transmittance of 99% or more cannot be easily obtained industrially. Thus, in practice, the light transmittance of the protective film is preferably in the range of 99% through 70%.

With consideration given to the protectivity and hygroscopic property of the scintillator layer, the moisture permeability of the protective film is preferably 50 g/m²·day or less (at 40° C. and 90% RH) (as measured by JIS Z0208), more preferably 10 g/m²·day or less (at 40° C. and 90% RH) (as measured by JIS Z0208). The film having a moisture permeability of 0.01 g/m²·day or less (at 40° C. and 90% RH) cannot be easily obtained industrially. Thus, in practice, the moisture permeability of the protective film is preferably in the range of 0.01 g/m²·day or more (at 40° C. and 90% RH) without exceeding 50 g/m²·day (at 40° C. and 90% RH) (as measured by JIS Z0208), more preferably 0.1 g/m²·day (at 40° C. and 90% RH) or more without exceeding 10 g/m²·day (at 40° C. and 90% RH) (as measured by JIS Z0208).

### (Substrate)

When manufacturing the scintillator panel of the present invention, various forms of substrates can be used. To be more specific, it is possible to use various types of glasses, polymer material, and metals that permit radiation such as X-ray to pass through. Examples include sheet glass such as quartz, borosilicate glass, chemically reinforced glass; ceramic substance such as sapphire, silicon nitride, silicon carbide; semiconductor substrate such as silicon, germanium, gallium arsenic, gallium phosphorus and gallium nitrogen; polymer film (plastic film) such as a cellulose acetate film, polyester film, polyethylene terephthalate film, polyamide film, polyimide film, triacetate film, polycarbonate film, and carbon fiber reinforced resin sheet; metallic sheet such as an aluminum sheet, iron sheet and copper sheet; and metallic sheet having a metal oxide coating layer.

Especially, the polymer film or the like containing polyimide or polyethylene naphthalate is preferably used when a columnar scintillator is formed by chemical vapor deposition method, using cesium iodide as a raw material. The substrate made of a flexible polymer film having a thickness of 50 through 500 μm is used with particular preference.

The term “flexible substrate” in the sense in which it is used here refers to the substrate wherein the modulus of elasticity (E120) at 120° C. is in the range of 1000 through 6000 N/mm². Preferred examples of such a substrate include the polymer film containing polyimide or polyethylene naphthalate.

The term “modulus of elasticity” corresponds to the inclination of stress relative to strain in an area wherein the strain indicated by the marked line of a sample in conformity to the JIS-C2318 and the stress corresponding thereto exhibit a linear relation, using an tension tester. This corresponds to the value called “Young's modulus”. In the present invention, This Young's modulus is defined as the modulus of elasticity.

In the substrate used of the present invention, the modulus of elasticity (E120) is preferably in the range of 1000 N/mm² through 6000 N/mm² at 120° C., as described above, more preferably in the range of 1200 N/mm² through 5000 N/mm² at 120° C., as described above.

The specific examples include a polymer film made up of polyethylene naphthalate (E120=4100 N/mm²), polyethylene terephthalate (E120=1500 N/mm²), polybutylene naphthalate (E120=1600 N/mm²), polycarbonate (E120=1700 N/mm²), syndiotactic polystyrene (E120=2200 N/mm²), polyether imide (E120=1900 N/mm²), polyarylate (E120=1700 N/mm²), polysulfone (E120=1800 N/mm²), and polyether sulfone (E120=1700 N/mm²).

They are used independently or in a laminated or mixed form. Among others, the polymer film used with particular preference is the polymer film containing polyimide or polyethylene naphthalate, as described above.

When the scintillator panel and flat light receiving element surface are bonded with each other, uniform image quality may not be obtained inside the light receiving surface of the flat panel detector under the influence of the deformation of the substrate or curling at the time of vapor deposition. To solve this problem, this substrate is made of the polymer film having a thickness of 50 μm or more without exceeding 500 μm. This arrangement ensures that the scintillator panel is deformed to the shape conforming to the shape of the flat light receiving element surface, with the result that uniform sharpness is obtained on the entire light receiving surface of the flat panel detector.

### (Scintillator Panel Manufacturing Method)

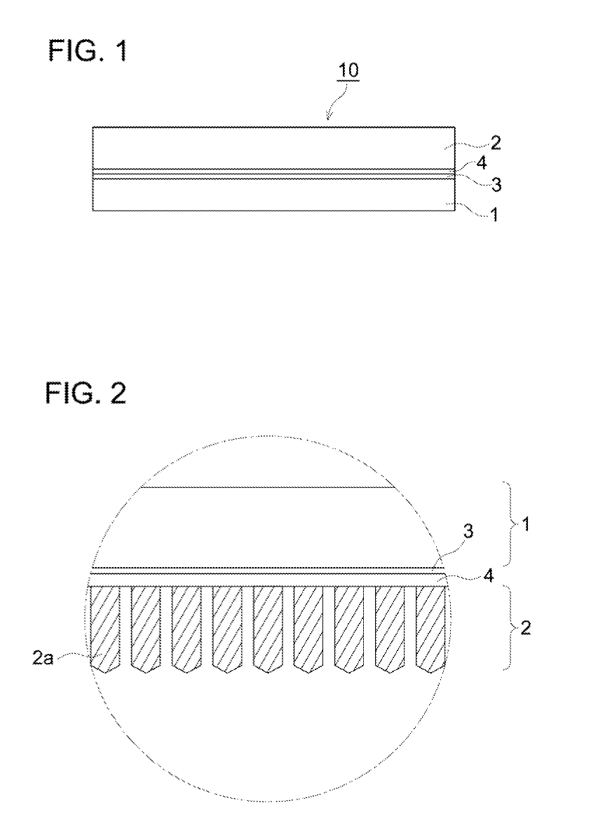

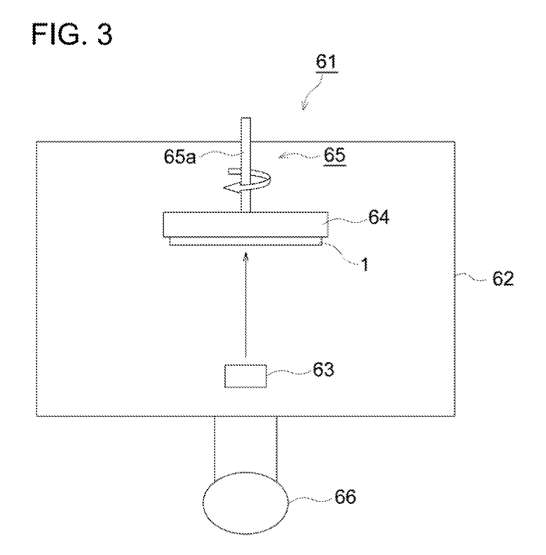

Referring to drawings, the following describes the typical example of the method of manufacturing a scintillator panel of the present invention: FIG. 1 is a cross sectional view showing the schematic structure of the radiation scintillator panel 10. FIG. 2 is an enlarged cross sectional view of the radiation scintillator panel 10. FIG. 3 is a drawing showing the schematic structure of the vacuum evaporation apparatus 61.

### (Vacuum Evaporation Apparatus>

As shown in FIG. 3, the vacuum evaporation apparatus 61 has a box-like vacuum container 62 and a boat 63 for vacuum evaporation is arranged inside the vacuum container 62. The boat 63 is a member in which vacuum evaporation source is charged. The boat 63 is connected with an electrode. When a current is sent to the boat 63 through the electrode, the boat 63 is heated by Joule heat. When the radiation scintillator panel 10 is manufactured, the boat 63 is charged with a mixture including cesium iodide and activator compound. When a current flows to this boat 63, the aforementioned mixture is heated and evaporated.

An alumina-made crucible wound with a heater can be used as the charged member wherever required, or a heater made of metal having a high melting point can be used.

A holder 64 holding the substrate 1 is arranged immediately above the boat 63 inside the vacuum container 62. The holder 64 is provided with a heater (not illustrated). The substrate 1 mounted on the holder 64 can be heated when this heater is operated. When the substrate 1 has been heated, it is possible remove the adsorbed substance on the surface of the substrate 1, to prevent the impurity layer from being formed between the substrate 1 and the scintillator layer (phosphor layer) 2, to reinforce the contact between the substrate 1 and the scintillator layer 2 formed on the surface thereof, and to adjust the film quality of the scintillator layer 2 formed on the surface of the substrate 1. In FIGS. 1 and 2, “3” represents a reflective layer and “4” represents a light absorbing layer.

The holder 64 is provided with a rotating mechanism 65 for rotating the holder 64. The rotating mechanism 65 is made of a rotary shaft 65a connected to the holder 64, and a motor (not illustrated) as a drive source thereof. When this motor is driven, the rotary shaft 65a rotates while the holder 64 is kept face to face with the boat 63.

In addition to the aforementioned structure, the vacuum evaporation apparatus 61 has a vacuum container 62 provided with a vacuum pump 66. The vacuum pump 66 is used to remove a gas from the vacuum container 62 and to introduce a gas into the vacuum container 62. When this vacuum pump 66 is operated, the interior of inside the vacuum container 62 is kept under the gas atmosphere having a predetermined pressure.

### <Scintillator Panel>

The following describes the method of manufacturing a scintillator panel 10 of the present invention:

In the method of manufacturing a scintillator panel 10, the aforementioned evaporation apparatus 61 can be preferably used. The following describes the method of manufacturing a radiation scintillator panel 10 using the evaporation apparatus 61

### <<Formation of a Reflective Layer>>

A thin metallic film (Al film, Ag film, etc.) as a reflective layer is formed on one of the surfaces of the substrate 1 by sputtering method. Further, various types of the films formed by sputtering and vacuum evaporation of an Al film on the polymer film are available on the market. They can be used as a substrate of the present invention.

### <<Formation of Light Absorbing Layer>>

The undercoating layer is produced by coating and drying the composition prepared by dispersing and dissolving the colorant and polymer binder in the aforementioned organic solvent. A hydrophobic resin such as polyester resin and polyurethane resin is preferably used as a polymer binder for the adhesiveness and corrosion resistance of the reflective layer.

### <<Formation of Scintillator Layer>>

As described above, a holder 64 is mounted on the substrate 1 provided with the reflective layer and undercoating layer and, at the same time, the boat 63 is charged with a powder mixture containing cesium iodide and thallium iodide (preparatory step). In this case, the distance between the boat 63 and substrate 1 is set to 100 through 1500 mm. The vacuum evaporation step (to be described later) is preferably carried out within the range of this set value.

After completion of the processing in the preparatory step, the vacuum pump 66 is operated to remove gas from the vacuum container 62. The interior of inside the vacuum container 62 is kept under the vacuum atmosphere having a pressure of 0.1 Pa or less (vacuum atmosphere creating step). The “vacuum atmosphere creating step” in the sense in which it is used here refers to the atmosphere having a pressure of 100 Pa or less. The atmosphere having a pressure of 0.1 Pa or less is preferably used.

After that, an inert gas such as argon is introduced into the vacuum container 62, and the interior of the vacuum container 62 is kept under the vacuum atmosphere of 0.1 Pa or less. Then the heater of the holder 64 and the motor of the rotating mechanism 65 are operated, and the substrate 1 mounted on the holder 64 is heated and rotated while it is kept face to face with the boat 63.

Under this condition, a current is fed from the electrode to the boat 63, and a mixture containing cesium iodide and thallium iodide is heated at about 700 through 800° C. for a predetermined time so that the mixture is made to evaporate. Thus, countless number of columnar crystals 2a grow sequentially on the surface of the substrate 1, with the result that a scintillator layer 2 having a desired thickness is formed (vacuum evaporation step). This procedure produces the radiation scintillator panel 10 of the present invention.

### (Radiation Image Detecting Apparatus)

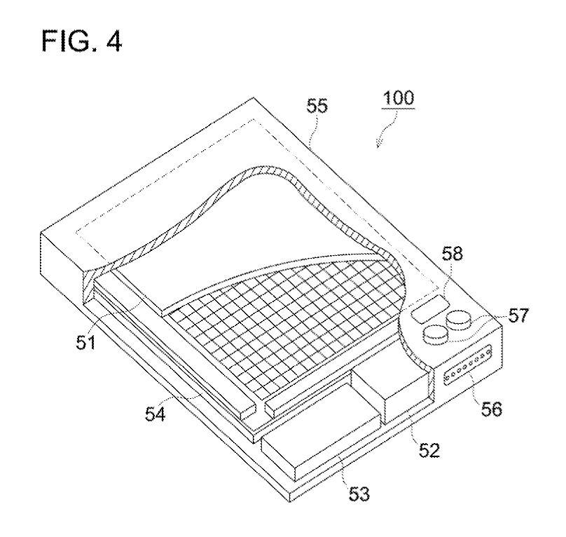

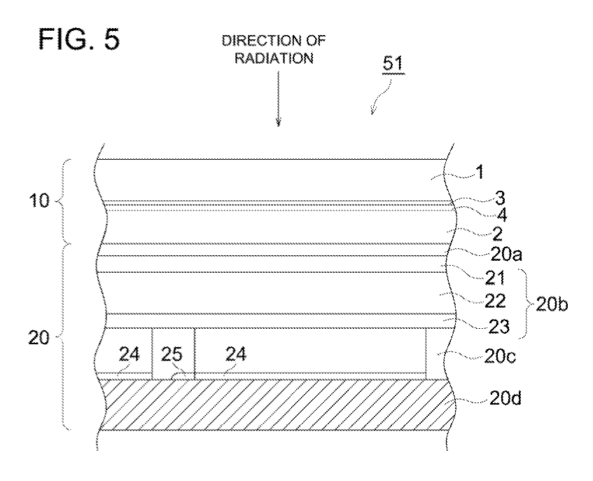

Referring to FIGS. 4 and 5, the following describes the structure of the radiation image detecting apparatus 100 equipped with a scintillator plate 10 for radiation, as an example of applying the aforementioned radiation scintillator panel 10. FIG. 4 is a partially cutaway perspective view representing the schematic structure of the radiation image detecting apparatus 100. FIG. 5 is an enlarged cross sectional view showing an imaging panel 51.

As shown in FIG. 4, the radiation image detecting apparatus 100 includes an imaging panel 51; a control section 52 for controlling the operation of the radiation image detecting apparatus 100; a memory section 53 as a storage means for storing the image signal output from the imaging panel 51 using a rewritable special-purpose memory (e.g. flash memory); and a power supply section 54 as a power supply means for supplying power required to get the image signal by driving the imaging panel 51. These components are arranged in an enclosure 55. Wherever required, the enclosure 55 is provided with a communication connector 56 to provide communication from the radiation image detecting apparatus 100 to the outside; an operation section 57 for switching the operation of the radiation image detecting apparatus 100; a display section 58 for showing that the preparation for imaging a radiation image has been completed and a predetermined amount of image signal has been written into the memory section 53 or the like.

Here the radiation image detecting apparatus 100 is provided with a power supply section 54 and a memory section 53 for storing the image signal of the radiation image. The radiation image detecting apparatus 100 is designed in such a way that it can be mounted or dismounted through the connector 56. When this arrangement is achieved, the radiation image detecting apparatus 100 is formed in a portable structure.

As shown in FIG. 5, the imaging panel 51 includes a radiation scintillator panel 10 and an output substrate 20 which absorbs the electromagnetic wave from the radiation scintillator panel 10 and outputs the image signal.

The radiation scintillator panel 10 is arranged on the side exposed to radiation, and is structured to emit the electromagnetic wave in conformity to the intensity of the incoming radiation.

The output substrate 20 is provided on the side of the radiation scintillator panel 10 opposite to the side exposed to the radiation. It is provided with a diaphragm 20a, photoelectric conversion element 20b, image signal output layer 20c and substrate 20d in that order starting from the side of the radiation scintillator panel 10.

The diaphragm 20a is used to separate the radiation scintillator panel 10 from other layers.

The photoelectric conversion element 20b is made up of a transparent electrode 21; a charge generation layer 22 for generating a charge through excitation by the electromagnetic wave coming through the transparent electrode 21; and a counter electrode 23 as a counter electrode of the transparent electrode 21. It is provided with a transparent electrode 21, charge generation layer 22 and counter electrode 23 in that order starting from the diaphragm 20a.

The transparent electrode 21 is an electrode to allow passage of the electromagnetic wave subjected to photoelectric conversion. It is formed of a conductive transparent material such as indium tin oxide (ITO), SnO2 and ZnO, for example.

On one of the surfaces of the transparent electrode 21, the charge generation layer 22 is formed in a thin film. As a compound capable of photoelectric conversion, it includes the organic compound that is charge-separated by light. It also includes conductive compounds as an electron doner and an electron acceptor capable of generating electric charge. In the charge generation layer 22, the electron doner is excited, upon entry of an electromagnetic wave, and discharges electrons. The discharged electrons travel to the electron acceptor, and electric charge, namely, a positive hole and electron carrier are generated in the charge generation layer 22.

In this case, the conductive compound as the electron doner is exemplified by a p-type conductive polymer compound. The p-type conductive polymer compound preferably has a basic skeleton of polyphenylene vinylene, polythiophene, poly (thiophene vinylene), polyacetylene, polypyrrole, polyfluorene, poly (p-phenylene) or polyaniline.

The conductive compound as the electron acceptor is exemplified by an n-type conductive polymer compound. The n-type conductive polymer compound preferably has a basic skeleton of polypyridine, more preferably a basic skeleton of poly (p-pyridyl vinylene).

The film thickness of the charge generation layer 22 is preferably 10 nm or more (especially 100 nm or more) because the amount of absorbed light can be ensured, and preferably 1 μm or less (especially 300 nm or less) because electric resistance does not become excessive.

The counter electrode 23 is arranged on the side of the charge generation layer 22, opposite to the side which the electromagnetic wave enters. The counter electrode 23 to be used can be selected from the electrodes made of general metal such as gold, silver and chromium, and the transparent electrode 21. To ensure excellent characteristics, a metal, alloy and electrically conductive compound of smaller work function (4.5 eV or less) as well as the mixture thereof are preferably used as an electrode substance.

A charge generation layer 22 and a buffer layer as a buffer zone to prevent these electrode from reacting with each other can be arranged between the electrodes (transparent electrode 21 and counter electrode 23) sandwiching the charge generation layer 22. The buffer layer is formed of lithium fluoride and poly(3,4-ethylenedioxythiophene): poly(4-styrene sulphonate), 2,9-dimethyl-4,7-diphenyl [1,10]phenanthroline, for example.

The image signal output layer 20c is used to store the charge obtained from the photoelectric conversion element 20b, and to output the signal based on the stored charge. The image signal output layer 20c is formed of a capacitor 24 as the charge storing element that ensures that the charge generated by the photoelectric conversion element 20b is stored for each pixel; and a transistor 25 as an image signal output element for outputting the stored charge as a signal.

The TFT (thin film transistor) is used as the transistor 25. This TFT can be an inorganic semiconductor TFT used in the liquid crystal display or the like, or an organic semiconductor TFT. It is more preferably a TFT formed on a plastic film. An amorphous silicon TFT is known as the TFT formed on a plastic film. Further, It is also possible to use the FSA (Fluidic Self Assembly) technology being developed by Alien Technology, U.S.A. wherein minute CMOSs (Nanoblocks) made of a single crystal silicon are arranged on an embossed plastic film, whereby the TFT is formed on a flexible plastic film. It is also possible to use the TFT using the organic semiconductor disclosed in such a journal as Science, 283, 822 (1999) Appl. Phys. Lett, 771488 (1998) and Nature, 403, 521 (2000).

As described above, the TFT manufactured by the aforementioned FSA technology and the TFT using an organic semiconductor are preferably used as the transistor 25 used in the present invention. The TFT using the organic semiconductor is used with particular preference. When the TFT is manufactured using this organic semiconductor, there is no need of using such a device as a vacuum vacuum evaporation apparatus, unlike the case of manufacturing the TFT using a silicon. Since printing technology or inkjet technology can be used to form the TFT, the production cost is reduced. Further, since the processing temperature can be kept low, the TFT can be formed on a plastic substrate less resistant to heat.

The transistor 25 stores the charge generated by the photoelectric conversion element 20b, and is further electrically connected with a collection electrode (not illustrated) serving as another electrode of the capacitor 24. The capacitor 24 stores the charge generated by the photoelectric conversion element 20b and the stored charge is read out by driving the transistor 25. To be more specific, a signal for each pixel of the radiation image can be output by driving the transistor 25.

The substrate 20d acts as a ubstrate of the imaging panel 51, and can be formed of the same material as that of the substrate 1.

The following describes the operation of the radiation image detecting apparatus 100:

In the first place, the radiation applied to the radiation image detecting apparatus 100 travels toward the substrate 20d from the side of the radiation scintillator panel 10 of the imaging panel 51.

Then the scintillator layer 2 in the radiation scintillator panel 10 absorbs the energy of the radiation having entered the radiation scintillator panel 10, and emits the electromagnetic wave of light conforming to the intensity thereof. Of the electromagnetic wave of light having been emitted, the electromagnetic wave entering the output substrate 20 reaches the charge generation layer 22 after passing through the diaphragm 20a of the output substrate 20 and the transparent electrode 21. The electromagnetic wave is absorbed by the charge generation layer 22, and a pair of the positive hole and electron (charge separation status) is formed in conformity to the intensity thereof.

The positive hole and electron of the charge having occurred thereafter are fed separately to different electrodes (transparent electrode film and conductive layer) by the internal electric field generated by application of the bias voltage by the power supply section 54, whereby a photoelectric current flows.

After that, the positive hole fed to the counter electrode 23 is stored in the capacitor 24 of the image signal output layer 20c. The stored positive hole outputs the image signal when the transistor 25 connected to the capacitor 24 has been driven. The output image signal is stored in the memory section 53.

The aforementioned radiation image detecting apparatus 100 is provided the radiation scintillator panel 10 capable of increasing the photoelectric conversion efficiency, and therefore, it enhances the SN ratio in a low-dose radiation image and prevents the image irregularity and linear noise from occurring.

### EXAMPLES

Referring to Examples, the following describes the details of the present invention, however, the present invention is not limited thereto.

### (Preparation of the Reflective Layer)

A reflective layer (0.01 μm) was formed by sputtering aluminum to a polyimide film (UPILEX-125S by Ube Industries, Ltd.) having a thickness of 125 μm.

(Preparation of the light abscrbing layer)

| | | |
|---|---|---|
| Byron 630 (polyester polymer resin by | 100 | parts by mass |
| Toyobo Co., Ltd.) | | |
| Colorant (see Table 1) | 0.1 | part by mass |
| Methylethyl ketone (MEK) | 100 | parts by mass |
| Toluene | 100 | parts by mass |

The aforementioned materials were mixed and were dispersed using a bead bill for 15 hours, whereby a coating liquid for coating a light absorbing layer was prepared. This coating liquid was applied on the aluminum-sputtered surface of the aforementioned substrate, using a bar coater, so that the dry film thickness as shown in Table 1.

The following colorants were used:

| | |
|---|---|
| No colorant: | A-1 |
| Colorant having a maximum absorption | B-1 diketopyrrolopyrrole |
| wavelength of less than 560 nm: | |
| Colorant having a maximum absorption | C-1 phthalocyanine blue, |
| wavelength of 560 through 650 nm: | C-2 ultramarine blue pigment |
| Colorant having a maximum absorption | D-1 phthalocyanine green |
| wavelength of larger than 650 nm: | |

### (Formation of Scintillator Layer)

A scintillator phosphor (CSI: 0.003Tl) was vacuum-evaporated on the light absorbing layer side of the substrate, using a vacuum evaporation apparatus shown in FIG. 3, whereby a scintillator (phosphor) layer was formed.

To be more specific, a resistance heating crucible was filled with the aforementioned phosphor material as a vacuum evaporation material in the first place. A substrate was installed in a rotating substrate holder, and the distance between the substrate and evaporation source was adjusted to 400 mm.

This is followed by the step of evacuating gas from the vacuum evaporation apparatus. Then argon gas was introduced therein. After the degree of vacuum was adjusted to 0.5 Pa, the temperature of the substrate was kept at 150° C. while the substrate was rotated at 10 rpm. Then the resistance heating crucible was heated so that the phosphor was vapor-deposited. The step of vacuum evaporation was terminated when the film thickness of the scintillator layer had reached 500 μm. Thus, a scintillator panel (radiation image conversion panel) was obtained.

### <Evaluation>

Each sample having been obtained was set on the CMOS flat panel (X-ray CMOS camera system Shad-o-Box4KEV by Rad Icon Co., Ltd.), and the sharpness was measured and evaluated based on the 12-bit output data according to the following procedure.

Sponge sheets were arranged on the carbon plate of the radiation incoming screen and on the radiation incoming side of the scintillator panel (the side having no phosphor). The flat light receiving element surface and scintillator panel were gently pushed together and were fixed in position.

### <Sharpness Evaluation Procedure>

The X-ray generated from a tube of which tube voltage is 80 kVp was applied from the rear surface (the side having no scintillator layer) of each sample through the lead-made MTF chart. The image data was detected on the CMOS flat panel arranged on the scintillator, and was recorded on a hard disk. After that, the record on the hard disk was analyzed by a computer, and the modulated transfer function MTF (MTF value in space frequency of 1 cycle/mm) of the X-ray image recorded on the hard disk was used as an index for sharpness. In the Table, a higher MTF value indicates a higher degree of sharpness. MTF stands for Modulation Transfer Function.

Table 1 shows the result of the aforementioned evaluation.

TABLE 1

| | MTF | | | | |
|---|---|---|---|---|---|
| Thickness | Compar- | Compar- | | | |
| of light | ative | ative | | | Comparative |
| absorbing | example | example | Example | Example | example |
| layer | Colorant | Colorant | Colorant | Colorant | Colorant |
| (μm) | A-1 | B-1 | C-1 | C-2 | D-1 |
| 0.1 | 0.55 | 0.53 | 0.67 | 0.66 | 0.62 |
| 0.2 | 0.55 | 0.51 | 0.73 | 0.72 | 0.63 |
| 1.0 | 0.55 | 0.51 | 0.73 | 0.72 | 0.63 |
| 2.5 | 0.55 | 0.51 | 0.73 | 0.72 | 0.63 |
| 3.0 | 0.52 | 0.50 | 0.65 | 0.65 | 0.62 |

As is apparent from the result in Table 1, a higher degree of sharpness can be achieved in the Example of the present invention than in the Comparative example. In this comparative test, all panels were provided with a reflective layer, and comparison was made when scintillator exhibited high light extraction efficiency.

What is claimed is:

1. A scintillator panel comprising a substrate having thereon a reflective layer and a scintillator layer, wherein a light absorbing layer having a maximum absorption wavelength of 560 to 650 nm is provided between the reflective layer and the scintillator layer.

2. The scintillator panel of claim 1, wherein the light absorbing layer comprises an organic colorant or an inorganic colorant.

3. The scintillator panel of claim 1, wherein the scintillator layer is formed by a vapor deposition method using a raw material comprising cesium iodide and an additive comprising thallium.

4. The scintillator panel of claim 1, wherein a thickness of the light absorbing layer is 0.2 to 2.5 μm.

5. The scintillator panel of claim 1, wherein the reflective layer comprises an element selected from the group consisting of Al, Ag, Cr, Cu, Ni, Ti, Mg, Rh, Pt and Au.
